(19) United States
(12) Patent Application Publication
(10) Pub. No.: US 2010/0323564 A1
(43) Pub. Date: Dec. 23, 2010

(54) Bifurcated Electrical Contact

(76) Inventors: Stephen H. Clark, New Lenox, IL (US); Kevin L. Russelburg, Bolingbrook, IL (US); Neil E. Janota, Addison, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/760,736

(22) Filed: Apr. 15, 2010

Related U.S. Application Data
(60) Provisional application No. 61/218,702, filed on Jun. 19, 2009.

(51) Int. Cl. H01R 4/48

(52) U.S. Cl. 439/862

(57) ABSTRACT

A bifurcated electrical contact includes first and second contact beams of different beam lengths and contact zones curved transverse to the beam lengths.

### CROSS-REFERENCE TO RELATED APPLICATIONS

The present application claims the benefits of U.S. Provisional Application Ser. No. 61/218,702 filed Jun. 19, 2009.

### FIELD OF THE INVENTION

The present invention relates generally to electrical contacts and connectors, and more specifically to contacts that are provided on wire ends for plugging connection to another electrical component.

### BACKGROUND OF THE INVENTION

It is known to provide electrically conductive bodies, often referred to as “contacts” on the ends of wires or cables for devices that may require connection and disconnection for installation, service, repair or replacement. The contact is connected electrically to the wire or cable by crimping, soldering, electrically conductive bonding agents, or the like. It is known to provide the contact as a comparatively rigid metal body of electrically conductive material that can withstand a required frequency of plugging and unplugging into and from another system component.

Contacts can be used in situations of varying adversities, including conditions of vibration. It is known to use springs of various types, including individual springs or spring structures built into the contact body to bias the contact beams against the mating contact in the connection. It is also known to use bifurcated constructions in which two spaced contact beams project from a single main contact body to provide discrete contact regions within the electrical connection assembly. However, under conditions of vibration the contact beams can vibrate in unison. This can result in situations in which both beams move away from the mating contact at substantially the same instant, thereby completely breaking electrical contact, causing circuit interruption. Stronger springs or spring designs in the contact can overcome some vibration; however, this can result in a contact that is difficult to plug and unplug due to the stiff and unyielding nature of the more strongly biased contact beams, or a contact that is undesirably bulky. In some situations, such as electrical connections in vehicle transmissions, complex connectors having pins or other components have been used, manufactured by more complex, time consuming and expensive processes such as welding or the like.

It is desirable to have a connector that can connect to insert-molded lead-frames that use very thin metal, of for example 0.010 inch thickness, to create conductive paths to sensors, switches and the like that are molded within a piece of plastic. It is common for such constructions to provide an exposed flat area for the connector to establish electrical connection to. Known designs of connectors for use in such applications have been undesirably complex.

### SUMMARY OF THE INVENTION

A bifurcated electrical contact is provided with contact beams that respond differently to vibration so that the beams will not vibrate in unison, improving the opportunity for at least one of the beams to be in contact within a connector even under adverse conditions.

In one aspect of one embodiment, a bifurcated electrical contact is provided with a base and first and second legs connected to the base and extending therefrom in spaced relation to each other on opposite sides of a void therebetween. The first leg has a first proximal transition from the base, a first contact beam extending from the first proximal transition angularly away from the base, and a first contact zone at an opposite end of the first contact beam from the first proximal transition. The second leg has a second proximal transition from the base, a second contact beam extending from the second proximal transition angularly away from the base, and a second contact zone at an opposite end of the second contact beam from the second proximal transition. The first contact beam has a first contact beam length from the first proximal transition to the first contact zone, and the second contact beam has a second contact beam length from the second proximal transition to the second contact zone. The first contact beam length is shorter than the second contact beam length.

In another aspect of an embodiment, a bifurcated electrical contact is provided with a first contact beam having a first beam length; a second contact beam having a second beam length; a base electrically connected to the first and second contact beams; and the first beam length being less than the second beam length.

In a further aspect of an embodiment, a bifurcated electrical contact is provided with a base; a first leg having a first curved proximal transition, a first contact beam extending from the first curved proximal transition at a first angle relative to the base, and a first contact zone; and a second leg having a second curved proximal transition, a second contact beam extending from the second curved proximal transition at a second angle relative to the base, and a second contact zone. The first angle is steeper than the second angle and the first and second contact zones are equally spaced from the base.

An advantage of an embodiment in a form of a bifurcated electrical contact is providing an electrical contact that has improved connectivity under conditions of vibration.

Another advantage of an embodiment in a form of a bifurcated electrical contact is providing an electrical contact that has improved connectivity to insert-molded lead-frames having thin electrical contact bodies presenting exposed flat areas for contact.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a bifurcated electrical contact;

FIG. 2 is a side elevational view of the bifurcated electrical contact;

FIG. 3 is a side elevational view of the bifurcated electrical contact, illustrating the side opposite the side shown in FIG. 2;

FIG. 4 is a cross-sectional view of the bifurcated electrical contact shown in FIG. 1, taken along line 4-4 of FIG. 1;

FIG. 5 is another cross-sectional view of the bifurcated electrical contact shown in FIG. 1, taken along line 5-5 of FIG. 1

FIG. 6 is a perspective view of another embodiment of a bifurcated electrical contact; and

FIG. 7 is a perspective view of still another embodiment of a bifurcated electrical contact.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

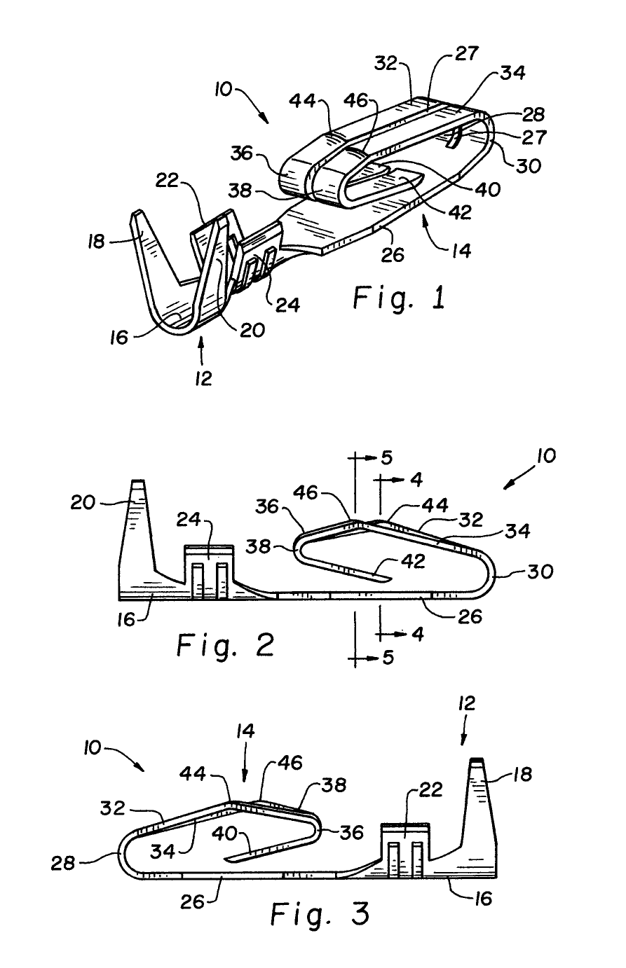

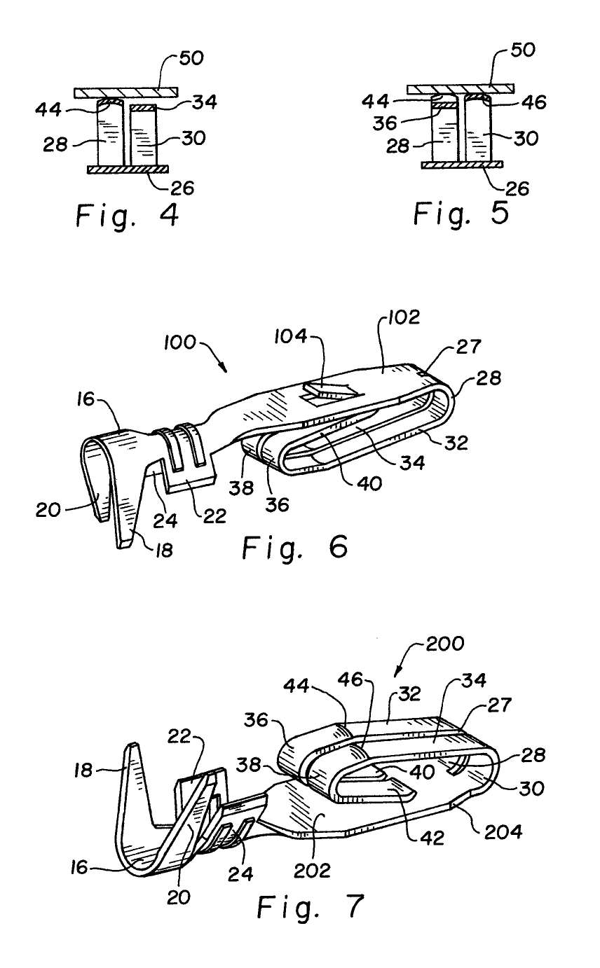

Referring now more particularly to the drawings and to FIG. 1 in particular, a bifurcated electrical contact 10 is shown. Contact 10 is a monolithic body of conductive material, such as conductive metal. Contact 10 includes a fastener portion 12 by which the contact is physically attached and electrically connected to a wire or cable. Contact 10 further includes an electrical contact portion 14 by which electrical connection is made to another system component by plug-in type connection of contact 10 to the other component.

Fastener portion 12 includes a trough-like base 16 for receiving a wire or cable. Opposed outer arms 18, 20 are provided for wrapping around and grasping the insulation or sheath of a wire or cable to which contact 10 is to be connected. Fastener portion 12 further includes somewhat smaller opposed inner arms 22, 24 for wrapping around and electrically connecting to the bared conductor of the wire or cable. Accordingly, contact 10 is physically connected to a wire or cable by crimping outer arms 18, 20 to the sheath of the cable or wire and by crimping inner arms 22, 24 to the bared conductor of the cable or wire. Electrical connection of connector 10 to a cable or wire is established by the physical contact between the bared conductor of the cable or wire and inner arms 22, 24 crimped there against. It should be understood that fastener portion 12 is merely an exemplary design for connecting the bifurcated fastener to a wire or cable both physically and electrically, and other fastener configurations also can be used. For example and not limitation, other types of crimping connections can be used; solder connections can be made between the connector and the conductor of the wire or cable, and disconnectable terminals such as screws can be used. Those skilled in the art will readily understand that the features of the bifurcated electrical contact to be described hereinafter are not limited in use or application by the particular type of fastener portion used to establish physical and electrical connection of the contact to a wire or cable.

Electrical contact portion 12 includes a base 26 extending from trough-like base 16 of fastener portion 12. It should be understood that base 16 and base 26 are merely different areas of the monolithic body forming contact 10. From base 26, contact 10 is bifurcated, extending in two separate and distinct legs from base 26 that are separated by a void 27 therebetween. The legs include curved proximal transitions 28 and 30 on opposite sides of void 27. Curved proximal transitions 28, 30 curve away from base 26 and lead to contact beams 32, 34, respectively, that extend in spaced relation to base 26 and are also separated from each other by void 27. Distal transitions 36, 38 are separated from one another by the continuation of void 27, angle away from contact beams 32, 34 and curve back toward base 26. Tails 40, 42, also separated from one another by void 27, extend from distal transitions 36, 38 respectively back toward proximal transitions 28, 30 in a space between base 26 and contact beams 32, 34. Tails 40, 42 are in spaced relationship to and between base 26 and contact beams 32, 34 with contact 10 in its uninstalled and non-deflected condition.

In a direction from proximal transitions 28, 30 toward distal transitions 36, 38, contact beams 32, 34 extend at angles away from base 26 so that contact zones 44, 46 are defined at areas of greatest distance from base 26, immediately before distal transitions 36, 38. Electrical connection to a mating component is made by the interfaces of contact zones 44, 46 against mating contact surfaces of the mating component.

The length of one contact beam is shorter than the length of the other contact beam between the curved proximal transition and the contact zone associated therewith. In the exemplary embodiment shown, the length of contact beam 32 between the end of proximal transition 28 and contact zone 44 is less than the length of contact beam 34 between the end of proximal transition 30 and contact zone 46. Accordingly, contact zone 44 is closer to proximal transition 28 than is contact zone 46 to proximal transition 30. The relative distances of contact zones 44 and 46 from base 26 are substantially the same, and, accordingly, contact beam 32 extends at a steeper angle from proximal transition 28 relative to base 26, than does contact beam 34 from proximal transition 30 relative to base 26. Under conditions of vibration, contact beams of different lengths vibrate at different frequencies. Accordingly, it is less likely that contact zones 44, 46 will be in a disconnected status simultaneously even if both are vibrated and intermittently separated from electrical contact; and more consistent, less interrupted electrical contact is provided through at least one of the contact zones 44, 46 at all times.

In an embodiment of a bifurcated electrical contact, contact zones 44, 46 are curved transverse to the length of contact beams 32, 34. This can be provided as curvature in the areas of contact zones 44, 46 only, or as a curvature of the entire length of contact beams 32, 34. The curvature of contact zones 44, 46 enhances micro-contact from the deformation of micro-peaks in the contact zones contacting mating surfaces of the mating system components to which contact 10 is connected, thereby providing improved electrical connection.

Contact 10 of the exemplary embodiment shown and described incorporates what is known as a full bellows design so that when contact 10 is inserted in a complementary receiving contact that is narrower in width than the distance between contact zones 44, 46 and base 26, and compression forces are exerted against beams 32, 34 the beams bend at proximal transitions 28, 30 until tails 40, 42 rest against the inner surface of base 26. Distal transitions 36, 38 then also provide support and spring biasing of contact beams 32, 34. As a result, both sets of transitions, proximal transitions 28, 30 and distal transitions 36, 38 function as spring supports for contact beams 32, 34 to hold contact zones 44, 46 against a mating contact member 50. Alternatively, a bifurcated electrical contact having contact beams of different lengths can be provided in other than a full bellows design, such as, for example, not having tails 40, 42 or even distal transitions 36, 38.

Proximal transitions 28, 30 and distal transitions 36, 38 have been shown and described as generally smoothly curved segments; however, it should be understood that the transitions can be more angularly shaped as well.

Various other features can be included in a bifurcated electrical contact as described herein, to further orient and secure the contact to a mating contact component. FIGS. 6 and 7 illustrate bifurcated electrical contacts 100 and 200, respectively, which include several of such features. Components of bifurcated electrical contacts 100 and 200 that are similar to corresponding components in bifurcated electrical contact 10 described herein are identified with the same reference numbers as used in describing bifurcated electrical contact 10.

Bifurcated electrical contact 100 shown in FIG. 6 includes a base 102 similar to base 26, but including an angular locking tab 104 extending away from base 102 on a side of base 102 opposite to the surface confronting contact beams 32, 34. Contact 100 can be latched physically to a mating component by engagement of locking tab 104 and an associated structure on the mating component, to thereby resist the unintended withdrawal of contact 100 from the mating component.

Bifurcated electrical contact 200 shown in FIG. 6 includes a base 202 similar to base 26, but including a lateral extension 204 on one or both side edges of base 202 to slide through a complementary slot in a connecting block or other mating connector in which contact 200 is ultimately installed. The lateral extension can aid in aligning contact 200 with the intended connection and promoting proper orientation of the connecting components to one another.

It should be understood that still other features can be used, and the features described above can be combined. For example, a bifurcated electrical contact can be provided having a base with both a locking tab 104 and a lateral extension 204.

A contact of the type described herein can be connected to an insert-molded lead-frame that has thin metal (for example 0.010″) to create conductive paths to sensors, switches and the like within a piece of plastic. The connector described herein can connect to an exposed flat area of the lead-frame with a simple construction that can withstand and function under conditions of vibration, such as may be experienced in a vehicle transmission, for example.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A bifurcated electrical contact, comprising:
a base;
first and second legs connected to said base and extending therefrom in spaced relation to each other, on opposite sides of a void therebetween;
said first leg having a first proximal transition from said base, a first contact beam extending from said first proximal transition angularly away from said base, and a first contact zone at an opposite end of said first contact beam from said first proximal transition;
said second leg having a second proximal transition from said base, a second contact beam extending from said second proximal transition angularly away from said base, and a second contact zone at an opposite end of said second contact beam from said second proximal transition;
said first contact beam having a first contact beam length from said first proximal transition to said first contact zone;
said second contact beam having a second contact beam length from said second proximal transition to said second contact zone; and
said first contact beam length being shorter than said second contact beam length.

2. The bifurcated electrical contact of claim 1, including first and second curved distal transitions from said first and second contact zones, respectively, each curved toward said base.

3. The bifurcated electrical contact of claim 2, including first and second tails from said first and second curved distal transitions, respectively; said first and second tails disposed between said base and said first and second contact beams.

4. The bifurcated electrical contact of claim 3, said first and second contact zones being curved transverse to the lengths of said contact beams.

5. The bifurcated electrical contact of claim 1, said first and second contact zones being curved transverse to the lengths of said contact beams.

6. The bifurcated electrical contact of claim 1, said base having an angular locking tab protruding therefrom.

7. The bifurcated electrical contact of claim 1, said base having a lateral extension.

8. A bifurcated electrical contact, comprising:
a first contact beam having a first beam length;
a second contact beam having a second beam length;
a base electrically connected to said first and second contact beams; and
said first beam length being less than said second beam length.

9. The bifurcated electrical contact of claim 8, said first and second contact beams having first and second contact zones, respectively; said first and second contact zones being curved transverse to the lengths of said contact beams.

10. The bifurcated electrical contact of claim 8, said bifurcated electrical contact being a full bellows contact.

11. The bifurcated electrical contact of claim 8, said base including an angular locking tab protruding therefrom.

12. The bifurcated electrical contact of claim 8, said base including a lateral extension.

13. A bifurcated electrical contact, comprising:
a base;
a first leg having a first curved proximal transition, a first contact beam extending from said first curved proximal transition at a first angle relative to said base, and a first contact zone;
a second leg having a second curved proximal transition, a second contact beam extending from said second curved proximal transition at a second angle relative to said base, and a second contact zone; and
said first angle being steeper than said second angle and said first and second contact zones being equally spaced from said base.

14. The bifurcated electrical contact of claim 13, said first and second contact zones being curved transverse to the lengths of said contact beams.

15. The bifurcated electrical contact of claim 13, said bifurcated electrical contact being a full bellows contact.

16. The bifurcated electrical contact of claim 15, said first and second contact zones being curved transverse to the lengths of said contact beams.

17. The bifurcated electrical contact of claim 13, including an angular locking tab protruding from said base.

18. The bifurcated electrical contact of claim 13, said base having a lateral extension.

19. The bifurcated electrical contact of claim 13, including a fastener portion contiguous with said base, said fastener portion being configured for physical attachment and electrical connection to a wire.

20. The bifurcated electrical contact of claim 13, said fastener portion including arms for gripping a wire.
